(19) United States
(12) Patent Application Publication
(10) Pub. No.: US 2017/0223909 A1
(43) Pub. Date: Aug. 10, 2017

(54) Combination maple fitting involving a plug on one end and a cap on the other end with a mounting clip on the side

(71) Applicant: Victor Edward Putnam, Cobleskill, NY (US)

(72) Inventor: Victor Edward Putnam, Cobleskill, NY (US)

(21) Appl. No.: 15/018,186

(22) Filed: Feb. 8, 2016

(51) Int. Cl. A01G 23/14

(52) U.S. Cl. CPC A01G 23/14

(57) ABSTRACT

This multi-purpose embodiment functions primarily as a cap for tubing that is used in the collection of sap from maple or any sap-producing trees. The wider dimension of the cap end allows it to fit around the outside of tubing, rather than inside like the prior art does. The significant advantage of this embodiment is that it will not stretch tubing. This reduces the likelihood of leakage and preserves the physical integrity of the tubing. It allows for labor and time saving by eliminating the need to remove stretched tubing ends. Furthermore, the tubing line will not need to be replaced as often. Acting as a cap, it allows for small amounts of air to enter the tubing, which facilitates vacuum cleaning of the system. Its design includes a clip type fastener that attaches directly to the tubing for secure off-season placement. The protrusion end of this embodiment can serve two functions: as a plug for most spile spout diameters (to seal against contaminants) and it can be used to stretch tubing that may not easily fit over a spile.

### CROSS REFERENCE

This application claims the benefit of Provisional Patent Application No. 62/176,052 to Victor E. Putnam filed on Feb. 9, 2015.

### BACKGROUND

Tubing systems are the standard practice in the maple industry for the transfer and collection of sap. Tubing systems require a variety of fittings to fulfill specific purposes. There is a diverse assortment of fitting types in use in the maple industry today. Each is designed to satisfy a specific purpose. However, there are no fittings on the market that achieve the same objectives as this embodiment.

For example, a t-cap maple fitting is intended to cover a spile during the off-season. However, its primary function is to connect the drop line and two pipelines together during the production season. Hence, its form is intended to accommodate that purpose. It is not similar in design or function to the combination maple fitting.

Additionally, the combination connector fitting in patent U.S. Pat. No. 4,299,053A to Buzzell involves two joined, detachable pieces and is intended to connect the ends of two pipelines together. The interface between the two components is vulnerable to leaking. In any case, its functionality does not coincide with that of the combination fitting embodiment.

Even today, in order to close tubing and prevent contamination during the off-season, a plug is inserted into each tubing end at the conclusion of the sap season. Remaining in place for most months of the year, this plug stretches the tubing. Even slight stretching is enough to allow sap leakage, the bane of all maple operations. This affects syrup production and requires extra time locating and repairing the leaks. By capping rather than plugging tubing ends, this embodiment circumvents these complications.

Additionally, there is no fitting on the market with a protrusion able to plug a variety of spile sizes.

In one multi-purpose fitting, this embodiment offers a solution in each of these areas. Until now, there has been no maple hardware on the market with similar design and functions to this embodiment. The cap covers and protects tubing ends without compromising their diameter, the clip allows for easy off-season storage, and the protrusion end can plug a variety of spile sizes. These functions help to preserve equipment and thereby save money and time for maple producers.

### SUMMARY

This multi-purpose embodiment is a one-piece fitting that will serve as a cap for tubing and also a plug for most spiles that are used by the maple industry at present. By fitting around the open ended outer perimeter of tubing (or drop lines), it does not cause stretching and thereby maintains the integrity of the tubing's inside diameter. This eliminates the need to remove compromised tubing ends and extends the life of the current pipeline which saves time, money, and labor costs. In addition, capping the tubing allows for a minute amount of air to enter the pipeline, which facilitates vacuum cleaning of the system. The mounting clip located on the side of the fitting fastens directly to the tubing for secure off-season containment. Well-arranged pipeline in storage will also be easier to unravel for installation during the next sap season. The protrusion end of the fitting can act as a plug for most standard spiles in storage or be used to stretch tubing to better fit certain spiles. All of these benefits are offered in this one multi-purpose fitting.

### DESCRIPTION OF DRAWINGS

The accompanying drawings further illustrate the measurements and physical characteristics of this embodiment.

FIG. 1: shows physical specifications and measurements of the combination fitting from top, side, front, and angled orientations.

FIG. 2: shows two cross-section views of the fitting: one lengthwise and one widthwise.

### DESCRIPTION OF PREFERRED EMBODIMENT

This embodiment pertains to a multi-purpose combination maple fitting.

The fitting is comprised of the following:
a one-piece body
This embodiment is anticipated to be made of plastic. However, it can be made of any other material or combination of materials.

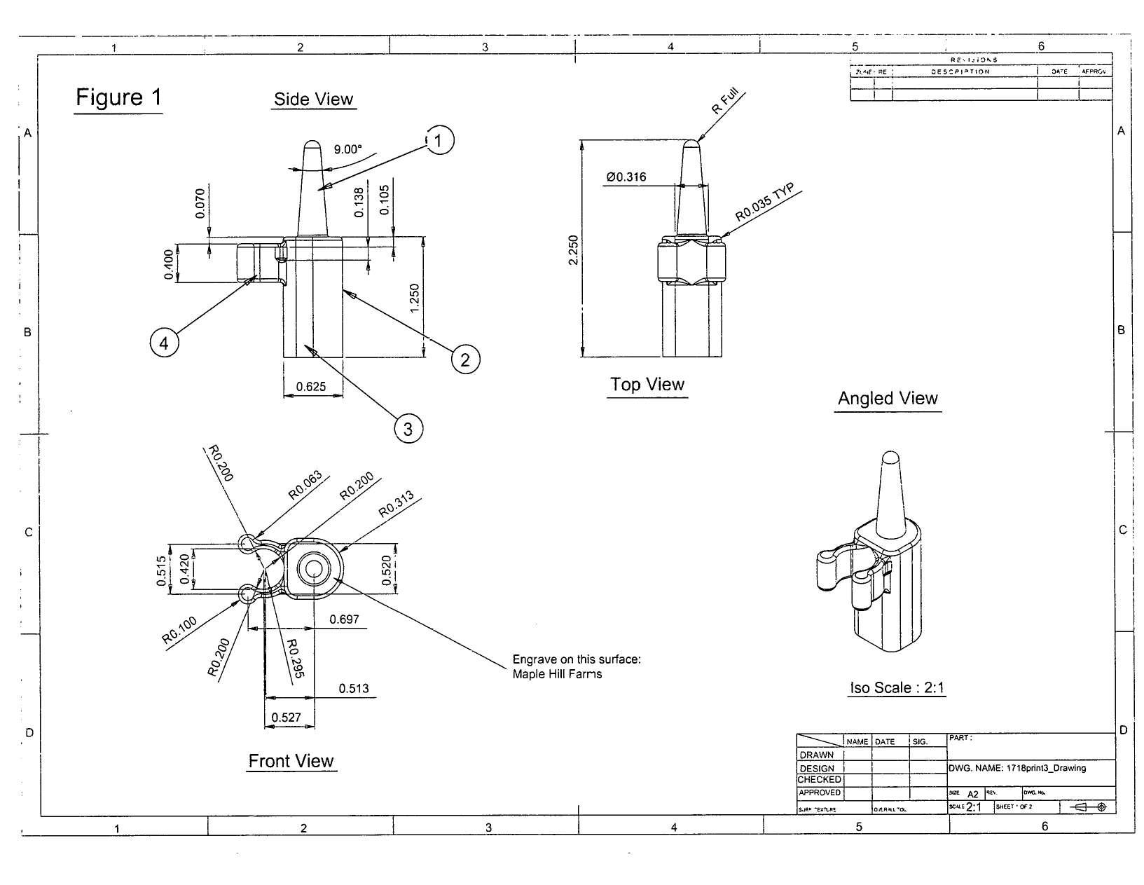

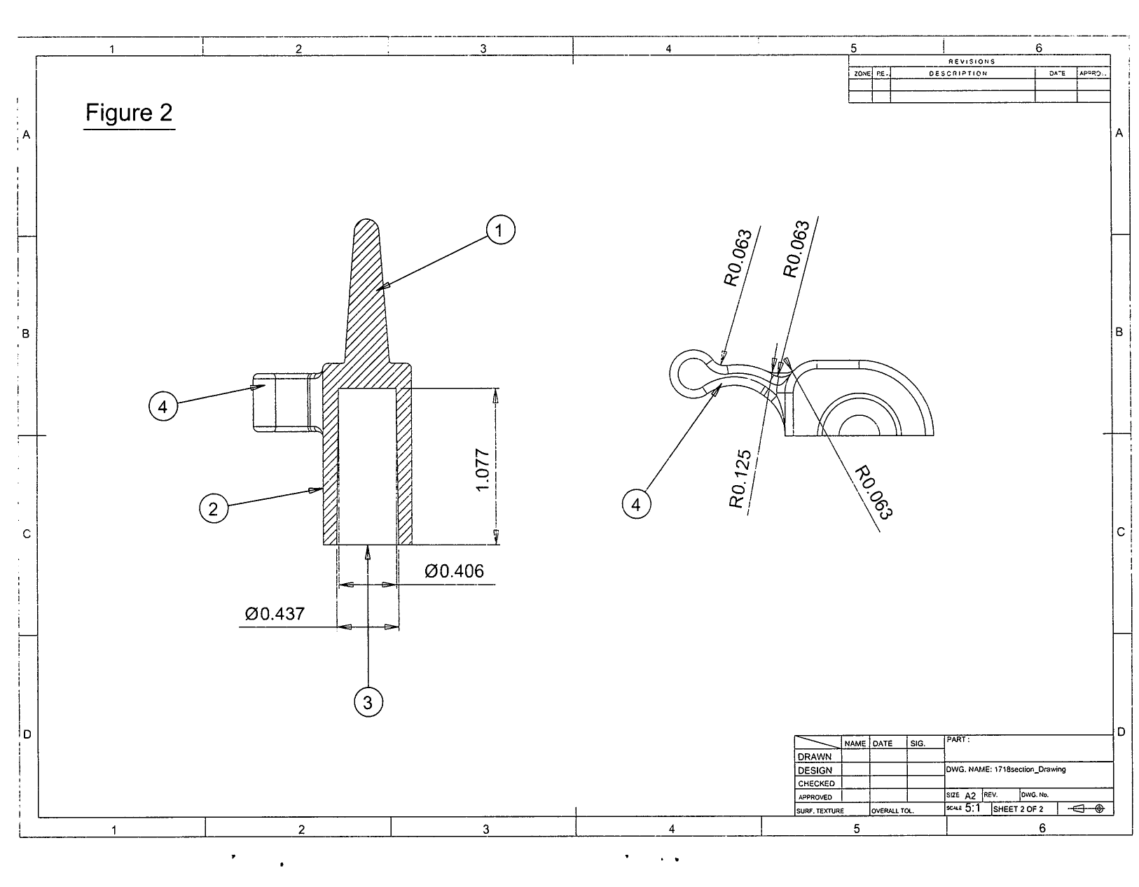

This fitting includes a plastic body (FIG. 1, no. 2) and (FIG. 2, no. 2) with a protrusion (FIG. 1, no. 1) on one end, a cap (FIG. 1, no. 3) on the other, and a clip (FIG. 1, no. 4) on the side.

The protrusion is tapered from base to tip (FIG. 2, no. 1)

The inner diameter of the cap hole is also slightly tapered (FIG. 2, no. 3)

The clip is a semi-circle with an enlarged point at each end (FIG. 2, no. 4)

The fitting is made in a precisely formed custom metal mold wherein liquid plastic is forced into the mold via high pressure. After the plastic is in place, the fitting cools and solidifies within the mold before it is removed.

1. A one-piece combination tubing fitting comprising a clip, a protrusion (protruded spile plug,) and a tubing cap.
